(19) United States
(12) Patent Application Publication
(10) Pub. No.: US 2022/0226088 A1
(43) Pub. Date: Jul. 21, 2022

(54) PORTABLE TOOTH CLEANING SYSTEM

(71) Applicant: OralKleen, LLC, Phoenix, AZ (US)

(72) Inventors: Gary LAUTERBACH, Scottsdale, AZ (US); Kurt KENZLER, Phoenix, AZ (US); Robert BRADY, Sarasota, FL (US); Matthew VERGIN, North St. Petersburg, FL (US); Barry JENNINGS, Largo, FL (US)

(21) Appl. No.: 17/153,786

(22) Filed: Jan. 20, 2021

(51) Int. Cl. A61C 17/22; A61C 17/36

(52) U.S. Cl. CPC A61C 17/227; A61C 17/36; A61C 17/222

(57) ABSTRACT

A tooth cleaning system includes a handheld toothbrush portion coupled by tubes to an arm-mounted module. Collectively, the handheld toothbrush portion and the arm-mounted module include an oscillating toothbrush head; an irrigation system having a pump, reservoir, and tubing; and a scavenge system having a pump, reservoir, and tubing. In some examples, portions of the irrigation system are disposed in the handheld toothbrush and portions of the irrigation system are disposed in the arm-mounted module.

### FIELD

This disclosure relates to systems and methods for dental hygiene. More specifically, the disclosed embodiments relate to toothbrush systems used by dental hygienists and other caregivers.

### INTRODUCTION

Individuals living in long-term care facilities, such as the elderly and people with physical and/or cognitive disabilities, often have difficulties performing hygiene activities involving fine motor control. Activities such as tooth brushing, which requires small, targeted arm and hand movements, may be challenging or impossible for people with conditions affecting motor function. In some examples, hygiene activities such as tooth brushing must be performed by attendants or nursing aides, as an individual may lack the physical or cognitive ability to perform the required tasks.

### SUMMARY

The present disclosure provides systems, apparatuses, and methods relating to self-contained, portable tooth cleaning systems.

A portable electric toothbrush system according to aspects of the present disclosure may include: an electric toothbrush having a head portion coupled to a handle, the head portion including a brush, an irrigation nozzle, and a scavenging port; a portable enclosure housing a first pump and a waste tank, the portable enclosure being coupled to the toothbrush by at least one flexible tube and comprising a sleeve, such that the portable enclosure is configured to be releasably securable to an arm of a user; and a water supply tank coupled to the irrigation nozzle of the electric toothbrush; wherein the at least one flexible tube includes a scavenging tube coupled at a first end to the scavenging port of the toothbrush and at a second end to the waste tank.

A portable electric toothbrush system according to aspects of the present disclosure may include: an electric toothbrush having a head portion coupled to a handle, the head portion including a brush and a scavenging port; a portable enclosure housing a vacuum pump coupled to a waste tank, the portable enclosure being coupled to the toothbrush by a flexible scavenging tube and comprising an arm sleeve configured to hold the portable enclosure to a forearm of a user; and a portable power supply electrically coupled to the vacuum pump; wherein the scavenging tube is coupled at a first end to the scavenging port of the toothbrush and at a second end to the waste tank.

A method for brushing the teeth of a subject according to aspects of the present disclosure may include: placing a brush end of an electric toothbrush into contact with one or more teeth in a mouth of the subject, wherein the electric toothbrush includes an irrigation nozzle and a scavenging port, and the electric toothbrush is coupled to a forearm-mounted enclosure housing a waste collection system; irrigating the mouth of the subject by pumping water from a water supply tank through the irrigation nozzle of the toothbrush; and scavenging waste from the mouth of the subject by pumping liquid through the scavenging port to the waste collection system.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of a first illustrative tooth cleaning system in accordance with aspects of the present disclosure.

FIG. 2 is an isometric view of an arm-mounted portion of a second illustrative tooth cleaning system in accordance with aspects of the present disclosure.

FIG. 3 is an isometric view of the illustrative tooth cleaning system of FIG. 2, illustrated with respect to a torso of a user.

FIG. 4 is an end view of an arm-mounted portion of the tooth cleaning system of FIG. 2, illustrated with the scavenge reservoir removed.

FIG. 5 is a side view of interior components of an arm-mounted portion of the tooth cleaning system of FIG. 2.

FIG. 6 is a top view of interior components of an arm-mounted portion of the tooth cleaning system of FIG. 2.

FIG. 7 is an isometric view of a third illustrative tooth cleaning system in accordance with aspects of the present disclosure.

FIG. 8 is an end view of an arm-mounted portion of the tooth cleaning system of FIG. 7, illustrated with the scavenge reservoir removed.

FIG. 9 is a side view of interior components of an arm-mounted portion of the tooth cleaning system of FIG. 7.

FIG. 10 is a top view of interior components of an arm-mounted portion of the tooth cleaning system of FIG. 7.

FIG. 11 is an isometric view of a fourth illustrative tooth cleaning system in accordance with aspects of the present disclosure.

FIG. 12 is an end view of an arm-mounted portion of the tooth cleaning system of FIG. 11, illustrated with the scavenge reservoir removed.

FIG. 13 is a side view of interior components of an arm-mounted portion of the tooth cleaning system of FIG. 11.

FIG. 14 is a top view of interior components of an arm-mounted portion of the tooth cleaning system of FIG. 11.

FIG. 15 is a is a flow chart depicting steps of an illustrative method for cleaning teeth according to the present teachings.

### DETAILED DESCRIPTION

Various aspects and examples of a tooth cleaning system, as well as related methods, are described below and illustrated in the associated drawings. Unless otherwise specified, a tooth cleaning system in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a self-contained tooth cleaning system in accordance with the present teachings may include a handheld toothbrush portion coupled to an arm-mounted module by tubing. Collectively, the system includes an oscillating toothbrush head, an irrigation system, and a suction system. Generally, the oscillating toothbrush head is disposed on the handheld toothbrush, and the irrigation system is disposed in the arm-mounted module. The irrigation system may include components of one or both of the handheld toothbrush and the arm-mounted module. Tubes extend between the arm-mounted module and ports disposed adjacent to the oscillating toothbrush head. An irrigation tube transports water from a water reservoir disposed either within the handheld toothbrush portion or within the arm-mounted module to an irrigation port. A suction (AKA scavenge) tube transports waste (e.g., water, bodily fluids, food waste, etc.) from a scavenge port to a scavenge reservoir disposed in or on the arm-mounted module. In general, systems of the present disclosure are self-contained in the sense that they do not require an interface with any other system to function fully, e.g., drainage, power, water source, etc., are included within the toothbrush, arm-mounted module, and interconnecting structures.

The handheld toothbrush portion includes an oscillating toothbrush head coupled to a toothbrush housing. The oscillating toothbrush head includes bristles and/or brushes coupled to a stem, which is caused to oscillate by a motor coupled to (e.g., disposed in) the toothbrush housing. The oscillating toothbrush head is configured to clean the teeth of a patient by providing brush agitation against surfaces of the patient's teeth. In some examples, the motor is powered by a plurality of batteries (e.g., housed within the toothbrush housing). In some examples, the toothbrush housing includes a charging port disposed at a bottom end of the housing, which is configured to mate with a charging stand. In some examples, the toothbrush housing includes a plurality of buttons and/or switches disposed on exterior surfaces of the toothbrush housing. The buttons may be configured to switch the oscillating toothbrush between an “on” state and an “off” state, and may be configured to switch the oscillating toothbrush between a variety of oscillation speeds.

The handheld toothbrush portion further includes an irrigation port and a scavenge port disposed adjacent the oscillating toothbrush head, which are configured to irrigate the mouth of a user and remove waste, respectively. In some examples, the oscillating toothbrush head, scavenge tube, and irrigation tube may be detachable from the toothbrush housing for cleaning. The handheld toothbrush portion may comprise any suitable rigid material for use in medical devices, such as plastics, metals, and/or the like. In some examples, the handheld toothbrush portion may include a resilient grip comprising any material which may be easily sterilized, such as rubber, resilient polymers, and/or the like.

In some examples, the handheld toothbrush portion includes one or more lights coupled to the handheld toothbrush portion. In some examples, the lights are directed toward the oscillating toothbrush head, such that the lights illuminate the mouth of a patient during use. In some examples, the handheld toothbrush portion includes a plurality (e.g., two) LED lights disposed within light housings coupled to a front surface of the handheld toothbrush portion. In some examples, the light housings are substantially tubular housings disposed around side portions of the LED lights, which direct light emitted by the LED lights parallel to a long axis of the handheld toothbrush portion. In some examples, the lights are electrically coupled to the plurality of buttons and/or switches, which are configured to switch the lights between an “on” state and an “off” state.

In some examples, the handheld toothbrush portion includes an irrigation system disposed within the toothbrush housing. In these examples, the irrigation system may include a water reservoir disposed within the housing, and a water pump. In some examples, the water pump includes a dual action mini peristaltic pump. In some examples, the water pump is manually actuated. The water reservoir may be coupled to the irrigation port by tubes coupled to an external surface of the toothbrush housing, or may be coupled to the irrigation port by internal hoses and/or lines. In some examples, the irrigation port is surrounded by bristles, such that water is expelled through the middle of the oscillating toothbrush head.

The arm-mounted module includes a module housing, which is configured to be coupled to the forearm of a user by way of an elastic band including any suitable fasteners such as hook-and-loop fasteners, snaps, buttons, and/or the like. In some examples, the housing is received within a sleeve comprising elastic material such as neoprene, fabrics comprising polyether-polyurea copolymers, synthetic polymer fabrics, and/or the like. In these examples, the elastic band is coupled to the sleeve (e.g., by sliding the elastic band into a loop coupled to the sleeve, hook-and-loop fasteners, sewing, etc.) In some examples, the elastic band is received within a pair of apertures disposed on external surfaces of the module housing and thereby fastened to the module housing. The module housing may include any suitable shape, such as rectangular, ovular, rounded, oblong, and/or the like. The module housing may comprise any suitable non-porous, sterile material, such as plastics, metals, and/or the like.

The arm-mounted module includes a power supply disposed near a distal end of the arm-mounted module. In some examples, the power supply is configured to power a single pump, which is configured to pump both water toward the handheld toothbrush, and waste from the toothbrush toward the arm-mounted module. In some examples, the power supply is configured to power a single scavenge pump. In some examples, the arm-mounted module includes a first power supply, configured to pump water toward the handheld toothbrush, and a second power supply, configured to pump waste toward the arm-mounted module. In some examples, the power supply comprises a battery, such as a rechargeable lithium-ion battery. In some examples, the power supply is coupled to a plurality of indicator light emitting diodes (LEDs), which indicate a state of charge of the power supply.

The arm-mounted module includes a scavenge reservoir configured to receive waste pumped away from the handheld toothbrush. In some examples, the scavenge reservoir may be disposed at a distal end of the arm-mounted module and may include a port which facilitates waste drainage. In some examples, the scavenge reservoir may be detached from the arm-mounted module for cleaning. The scavenge reservoir is coupled to the scavenge tube by an internal scavenge line. In some examples, the scavenge tube may be coupled to the scavenge line by way of a scavenge inlet disposed at a proximal end of the arm-mounted module, which functions as a coupling.

In some examples, the internal scavenge line may be coupled to the scavenge reservoir, and may be detached from the arm-mounted module for cleaning.

In some examples, the arm-mounted module includes a water reservoir and water pump disposed within the module housing, and an irrigation outlet disposed at a proximal end of the arm-mounted module. The irrigation outlet may function as a coupling between the freshwater reservoir and the irrigation tube.

A method of cleaning a patient's teeth may include agitating the surface of the teeth with the oscillating toothbrush head, irrigating the mouth with the irrigation system, and removing waste with the scavenge system.

### EXAMPLES, COMPONENTS, AND ALTERNATIVES

The following sections describe selected aspects of illustrative tooth cleaning system as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. First Illustrative Tooth Cleaning System

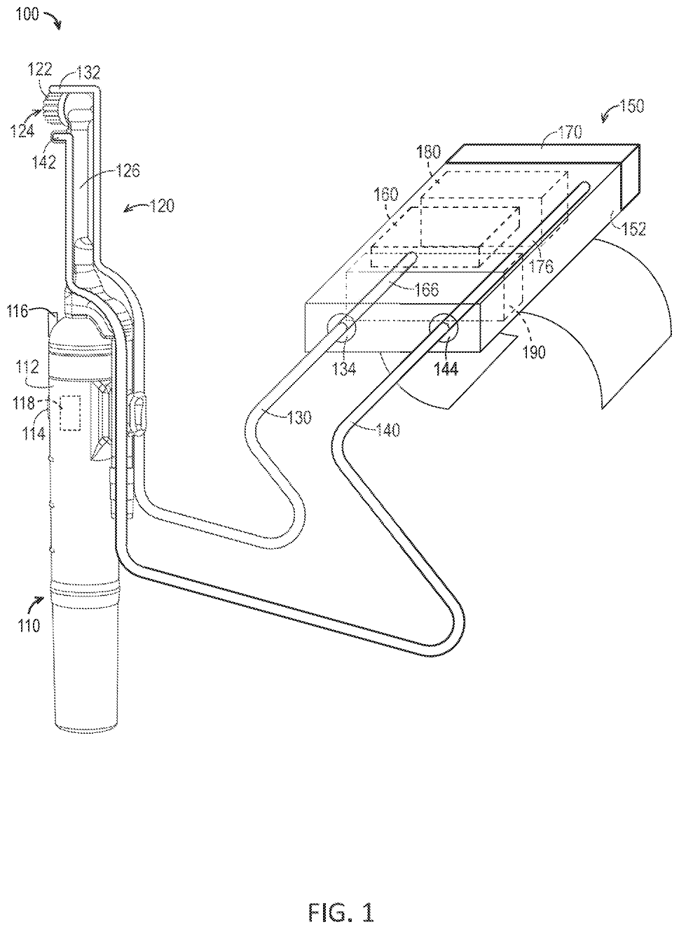

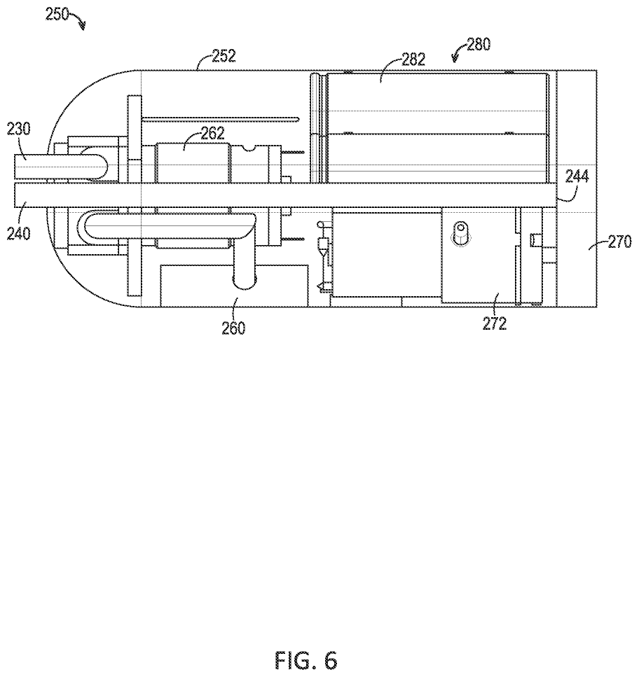

As shown in FIGS. 1-6, this section describes a first illustrative tooth cleaning system 100. FIG. 1 is a schematic diagram of tooth cleaning systems according to aspects of the present disclosure.

As illustrated in FIG. 1, tooth cleaning system 100 includes a handheld toothbrush portion 110 coupled by a flexible irrigation tube 130 and a flexible scavenge tube 140 to an arm-mounted module 150. Handheld toothbrush portion includes a toothbrush housing 112 coupled to an oscillating toothbrush head 120. Oscillating toothbrush head 120 may be removably coupled to housing 112 (e.g., by a threaded or friction fit) such that head 120 may be detached from all electronic components for cleaning (e.g., using a dishwasher, autoclave, etc.).

Toothbrush housing (AKA handle) 112 is configured to house a power supply and motor (not shown), which collectively oscillate toothbrush head 120. The motor may include any suitable prime mover configured to rotate and/or oscillate bristles of a toothbrush head, such as an electric motor (e.g., a brushed DC motor), a human powered oscillator, an inductive motor, a heat-powered motor, and/or the like. Housing 112 may include a user interface, such as a plurality of buttons and/or switches 114 disposed on exterior surfaces of the housing, which may be configured to switch the motor between “on” and “off” states. In some examples, buttons 114 are configured to switch the motor between a variety of oscillation speeds. In some examples, buttons 114 are configured to control functions of components associated with arm-mounted module 150, such as irrigation and scavenge. Housing 112 may comprise any suitable structural material for use in medical devices, such as plastics, metals, and/or the like. In some examples, the handheld toothbrush portion may include a resilient grip comprising any material which may be easily sterilized, such as rubber, resilient polymers, and/or the like.

In some examples, toothbrush housing 112 includes one or more lights 116 coupled to the toothbrush housing. In some examples, the lights are directed toward oscillating toothbrush head 120, such that the lights illuminate the mouth of a patient during use. In some examples, the handheld toothbrush portion includes a plurality (e.g., two) LED lights disposed within light housings coupled to a front surface of the toothbrush housing. In some examples, the light housings are substantially tubular housings disposed around side portions of the LED lights, which direct light emitted by the LED lights parallel to a long axis of the handheld toothbrush portion. In some examples, the lights are electrically coupled to the plurality of buttons and/or switches 114, which are configured to switch the lights between an “on” state and an “off” state.

In some examples, toothbrush housing 112 and/or arm-mounted module 150 includes a controller or chip 118 which connects tooth cleaning system 100 to a host server such that the tooth cleaning system is a component of an internet of things (IOT) system. Controller 118 may collect data while the tooth cleaning system is in use, which may later be uploaded to the Internet and aggregated. The data may be analyzed to determine user activity trends, such as total time used per day, total number of power up cycles, length of each power cycle, load data, and/or the like. The data may be utilized by a third party (e.g., health insurance carrier, physician) to verify that a patient is receiving a required or prescribed standard of care. In some examples, an insurance carrier may cover device costs after verifying that the device is used regularly as a component of a patient care regimen. Oscillating toothbrush head 120 includes a plurality of bristles 122 forming a brush head 124. Bristles 122 may be arrayed in any suitable arrangement for a toothbrush head, such as circular, ovular, rectangular, and/or the like. Brush head 124 is coupled to a stem 126, which is configured to oscillate as controlled by the motor. In some examples, stem 126 includes a protrusion disposed at a proximal end, which is configured to interface with the motor when the toothbrush head is coupled to the toothbrush housing. Toothbrush head 120 may comprise any suitable rigid material for use in medical devices, such as plastics, metals, and/or the like.

Coupled to oscillating toothbrush head 120 are an irrigation port or nozzle 132 and a scavenge port 142. Irrigation nozzle 132 is coupled to irrigation tube (AKA water supply tube) 130, and may be formed as a single piece with the tube. Irrigation nozzle 132 includes an opening or aperture at a distal end of irrigation tube 130, and is configured to direct the flow of water from tube 130 into the mouth of a patient. In some examples, irrigation nozzle 132 comprises flexible tubing. In some examples, irrigation nozzle 132 comprises rigid tubing. Irrigation tube 130 comprises any suitable resilient material for use in medical tubing, such as silicone, polyvinyl chloride, latex, ethyl vinyl acetate, Tygon, and/or the like. In some examples, irrigation nozzle 132 may be disposed at or adjacent a distal end of the oscillating toothbrush head.

Scavenge port (AKA scavenging port, scavenge nozzle) 142 is coupled to scavenge tube or scavenging tube 140, and may be formed as a single piece with scavenge tube 140. Scavenge port 142 includes an opening or aperture at a distal end of scavenge tube 140, and is configured to facilitate the intake of waste (e.g., water, bodily fluids, food waste, etc.) from the mouth of a patient into tube 140, for example by suction. In some examples, scavenge port 142 comprises flexible tubing. In some examples, scavenge port 142 comprises rigid tubing. Scavenge tube 140 comprises any suitable resilient material for use in medical tubing, such as silicone, polyvinyl chloride, latex, ethyl vinyl acetate, Tygon, and/or the like. In some examples, scavenge port 140 may be disposed at or adjacent a proximal side of brush head 124.

Irrigation tube 130 and scavenge tube 140 may be configured to releasably mate with recesses, clamps, or channels disposed on an exterior surface of toothbrush housing 112, such that tubes 130 and 140 may be retained against toothbrush housing 112 when the toothbrush is in use, but may be detached from housing 112 for cleaning. In some examples, tubes 130 and 140 are heat-resistant and configured to be sanitized (e.g., using a dishwasher, autoclave, etc.).

Irrigation tube 130 and scavenge tube 140 may interface with arm-mounted module 150 through an irrigation outlet 134 and an scavenge inlet 144 disposed at a proximal end of the arm-mounted module. In some examples, irrigation outlet 134 and scavenge inlet 144 comprise rigid tubes configured to mate with irrigation tube 130 and scavenge tube 140. In some examples, irrigation outlet 134 and scavenge inlet 144 comprise couplings, seals, or valves, which may provide a water-sealable fit when tubes 130 and 140 are inserted into the couplings.

Arm-mounted module (AKA portable enclosure) 150 includes housing 152 at least partially enclosing a water supply tank 160 coupled to the irrigation outlet by an irrigation line 166, a scavenge reservoir 170 coupled to the scavenge inlet by a scavenge line 176, a power supply 180, and a dual-action pump 190 configured to pump fluid into and out of the reservoirs.

Housing 152 includes an elongate (e.g., rectangular, cuboidal, or the like) capsule, which is configured to retain and protect internal components associated with the arm-mounted module. In some examples, housing 152 includes a lid and a base, which are configured to snap together and apart, providing access to the internal components. Housing 152 is configured to be coupled and/or releasably secured to the arm (e.g., forearm) of a wearer via an armband or sleeve 154. Armband 154 comprises an elastic material, such as neoprene, fabrics comprising polyether-polyurea copolymers, synthetic polymer fabrics, and/or the like. Armband 154 is configured to loop around the arm of the wearer and fasten to itself, using any suitable fastener such as hook-and-loop fasteners, snaps, buttons, and/or the like. In some examples, housing 152 includes a pair of slots, apertures, and/or openings disposed in a back surface, which are configured to receive the armband. In some examples, housing 152 is configured to be received by an elastic sleeve, to which the armband is coupled (e.g., sewn, attached with hook-and-loop fasteners, etc.).

In some examples, housing 152 includes recesses disposed in external surfaces which are configured to receive water supply tank 160 and scavenge reservoir 170. For example, housing 152 may include an opening 164 disposed in a side portion of the housing, which is configured to receive water supply tank 160. Water supply tank 160 comprises a refillable and/or modular tank, which may include a sealing lid and is configured to fit snugly within opening 164. In some examples, housing 152 may include fasteners configured to retain water supply tank 160 within the housing. In some examples, the elastic sleeve is configured to retain the water supply within the housing. Water supply tank 160 is removable through opening 164, and may be filled and/or disinfected while disconnected from housing 152. In some examples, irrigation line 166 is similarly removable through opening 164.

Housing 152 includes a recess 174 disposed at a distal end of arm-mounted module 150. In some examples, the entire distal end of module 150 is open and configured to mate with scavenge reservoir 170. Scavenge reservoir 170 comprises a tank (e.g., modular and/or disposable), which may include a sealing lid and is configured to fit snugly within recess 174. In some examples, housing 152 includes fasteners configured to retain scavenge reservoir 170 within the housing. In some examples, the elastic sleeve is configured to retain the water supply within the housing. In some examples, scavenge reservoir 170 is configured to mate with housing 152 in a friction fit. Scavenge reservoir 170 may be detached from recess 174 for emptying and/or disinfection while disconnected from housing 152. In some examples, scavenge line 176 is similarly removable through recess 174.

Water supply tank 160 holds fresh (e.g., potable) water, which is configured to be pumped away from module 150 toward the oscillating toothbrush head. Similarly, scavenge reservoir 170 is configured to hold waste collected from the mouth of the patient. Accordingly, water supply tank 160 and scavenge reservoir 170 interface with a pump 190 which is configured to pump water out of the water supply and to pump waste into the scavenge reservoir. Pump 190 pumps water from water supply tank 160, through irrigation line 166 and through the pump into irrigation tube 130. The water then travels through the irrigation tube into the mouth of the patient. Pump 190 suctions waste and water from a patient's mouth, through scavenge tube 140, through scavenge inlet 144, through scavenge line 176, and into scavenge reservoir 170. In some examples, pump 190 is a peristaltic pump, although any suitable pump may be utilized.

Pump 190 is powered by a power supply 180. In some examples, power supply 180 includes a battery or a plurality of batteries. In some examples, power supply 180 is a rechargeable, e.g., lithium-ion battery. In some examples, power supply 180 is a plurality of alkaline batteries. In some examples, arm-mounted module 150 includes LED indicators disposed on an external surface, which are configured to indicate a pump power level to a user. In some examples, pump 190 is configured to either pump water or suction scavenged water and waste. In these examples, arm-mounted module 150 includes buttons, switches, and/or other controls disposed on an external surface and configured to switch the pump between an irrigation mode and a scavenge mode.

Arm-mounted module 150 may be any suitable size for an arm-mounted system. In some examples, arm-mounted module may have a length of 5 inches to 7 inches, a width of 2 inches to 3 inches, and a height of 1.5 inches to 2.5 inches.

### B. Second Illustrative Tooth Cleaning System

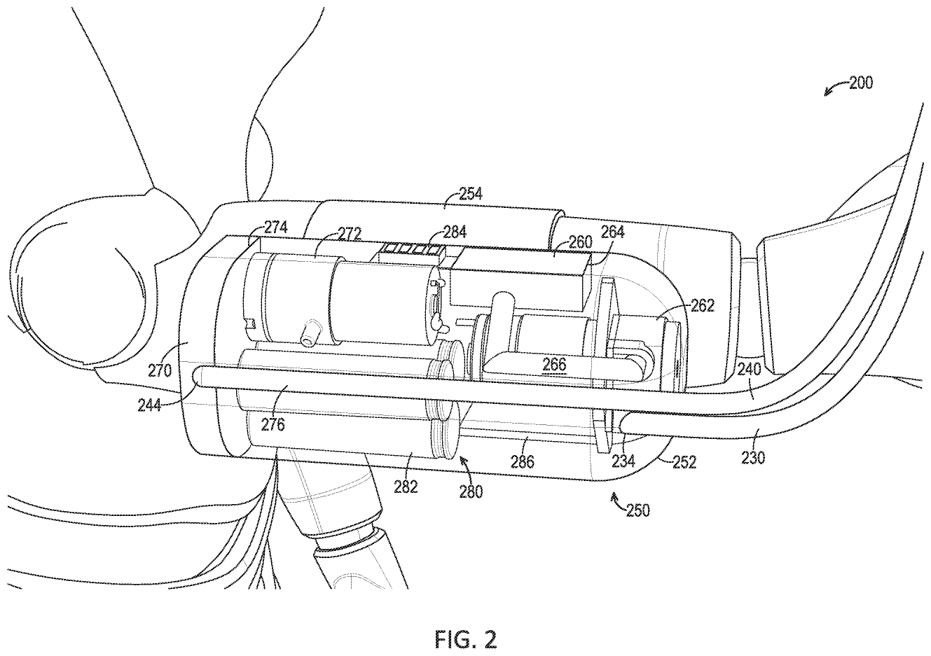

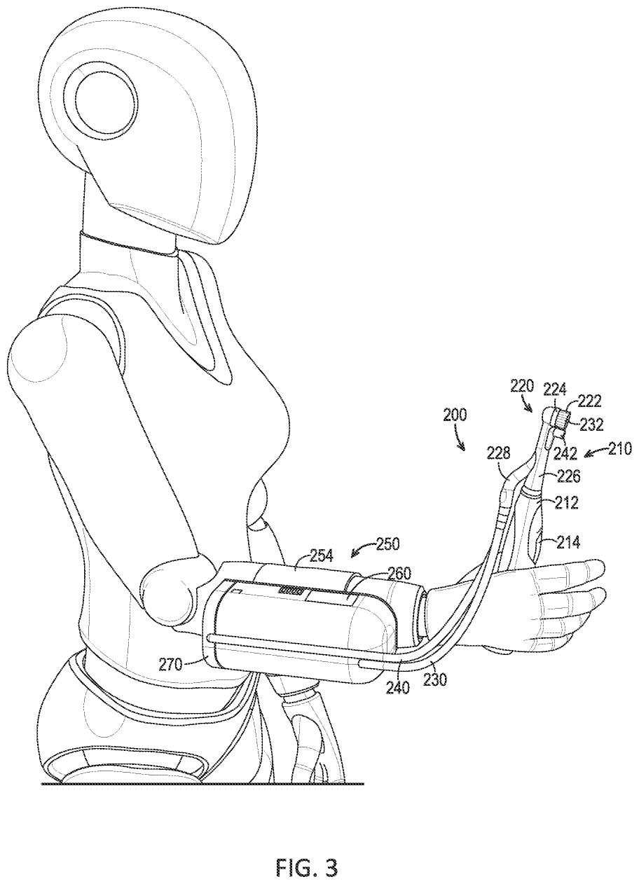

As shown in FIGS. 2-6, this section describes a second illustrative tooth cleaning system 200. FIGS. 2 and 3 are isometric drawings of the second illustrative tooth cleaning system in a close-up view and as worn by a user, respectively. In some examples, second illustrative tooth cleaning system 200 is substantially identical to first illustrative tooth cleaning system 100, except as described below.

As illustrated in FIGS. 2 and 3, tooth cleaning system 200 includes a handheld toothbrush portion 210 coupled by a flexible irrigation tube 230 and a flexible scavenge tube 240 to an arm-mounted module 250. Handheld toothbrush portion 210 includes a toothbrush housing 212 coupled to an oscillating toothbrush head 220. Oscillating toothbrush head 220 may be removably coupled to housing 212 (e.g., by a threaded or friction fit) such that head 220 may be detached from all electronic components for cleaning (e.g., using a dishwasher, autoclave, etc.).

Toothbrush housing (AKA handle) 212 is configured to house a power supply and motor (not shown), which collectively oscillate toothbrush head 220. The motor may include any suitable prime mover configured to rotate and/or oscillate bristles of a toothbrush head, such as an electric motor (e.g., a brushed DC motor), a human powered oscillator, an inductive motor, a heat-powered motor and/or the like. Housing 212 may include a user interface, such as a plurality of buttons and/or switches 214 disposed on exterior surfaces of the housing, which may be configured to switch the motor between “on” and “off” states. In some examples, buttons 214 are be configured to switch the motor between a variety of oscillation speeds. In some examples, buttons 214 are configured to control functions of components associated with arm-mounted module 250, such as irrigation and scavenge. Housing 212 may comprise any suitable structural material for use in medical devices, such as plastics, metals, and/or the like. In some examples, the handheld toothbrush portion may include a resilient grip comprising any material which may be easily sterilized, such as rubber, resilient polymers, and/or the like.

In some examples, toothbrush housing 212 includes one or more lights coupled to the toothbrush housing. In some examples, the lights are directed toward oscillating toothbrush head 220, such that the lights illuminate the mouth of a patient during use. In some examples, the handheld toothbrush portion includes a plurality (e.g., two) LED lights disposed within light housings coupled to a front surface of the toothbrush housing. In some examples, the light housings are substantially tubular housings disposed around side portions of the LED lights, which direct light emitted by the LED lights parallel to a long axis of the handheld toothbrush portion. In some examples, the lights are electrically coupled to the plurality of buttons and/or switches, which are configured to switch the lights between an “on” state and an “off” state. Oscillating toothbrush head 220 includes a plurality of bristles 222 forming a brush head 224. Bristles 222 may be arrayed in any suitable arrangement for a toothbrush head, such as circular, ovular, rectangular, and/or the like. Brush head 224 is coupled to a stem 226, which is configured to oscillate as controlled by the motor. In some examples, stem 226 includes a protrusion disposed at a proximal end, which is configured to interface with the motor when the toothbrush head is coupled to the toothbrush housing. Toothbrush head 220 may comprise any suitable rigid material for use in medical devices, such as plastics, metals, and/or the like.

Coupled to oscillating toothbrush head 220 are an irrigation port or nozzle 232 and a scavenge port 242. Irrigation nozzle 232 is coupled to irrigation tube 230, and may be formed as a single piece with the tube. Irrigation nozzle 232 is configured to direct the flow of water from tube 230 into the mouth of a patient. In some examples, irrigation nozzle 232 comprises flexible tubing. In some examples, irrigation nozzle 232 comprises rigid tubing. Irrigation tube 230 comprises any suitable resilient material for use in medical tubing, such as silicone, polyvinyl chloride, latex, ethyl vinyl acetate, Tygon, and/or the like.

Scavenge port (AKA scavenging port, scavenge nozzle) 242 is coupled to scavenge tube or scavenging tube 240, and may be formed as a single piece with scavenge tube 240. Scavenge port 242 is configured to facilitate the intake of waste (e.g., water, bodily fluids, food waste, etc.) from the mouth of a patient into tube 240, for example by suction. In some examples, scavenge port 242 comprises flexible tubing. In some examples, scavenge port 242 comprises rigid tubing. Scavenge tube 240 comprises any suitable resilient material for use in medical tubing, such as silicone, polyvinyl chloride, latex, ethyl vinyl acetate, Tygon, and/or the like.

In some examples, irrigation port 232 and scavenge port 242 are formed as a single piece, and include a single tube extending proximally from brush head 224 toward the arm-mounted unit. In these examples, irrigation port 232 and scavenge port 232 may include proximally-located ports to which irrigation tube 230 and scavenge tube 140 may couple. In some examples, toothbrush head 220 includes a sleeve 228 through which irrigation tube 230 and scavenge tube 240 may be fed. Sleeve 228 may retain tubes 230 and 240 adjacent the toothbrush head while the toothbrush portion is in use. Tubes 230 and 240 may be removed from sleeve 228 for cleaning. In some examples, tubes 230 and 240 are heat-resistant and configured to be sanitized (e.g., using a dishwasher, autoclave, etc.).

Irrigation tube 230 and scavenge tube 240 may interface with arm-mounted module 250 through an irrigation outlet 234 and an scavenge inlet 244 disposed at a proximal end of the arm-mounted module. In some examples, irrigation outlet 234 and scavenge inlet 244 comprise rigid tubes configured to mate with irrigation tube 230 and scavenge tube 240. In some examples, irrigation outlet 234 and scavenge inlet 244 comprise couplings, seals, or valves, which may provide a water-tight fit when tubes 230 and 240 are inserted into the couplings.

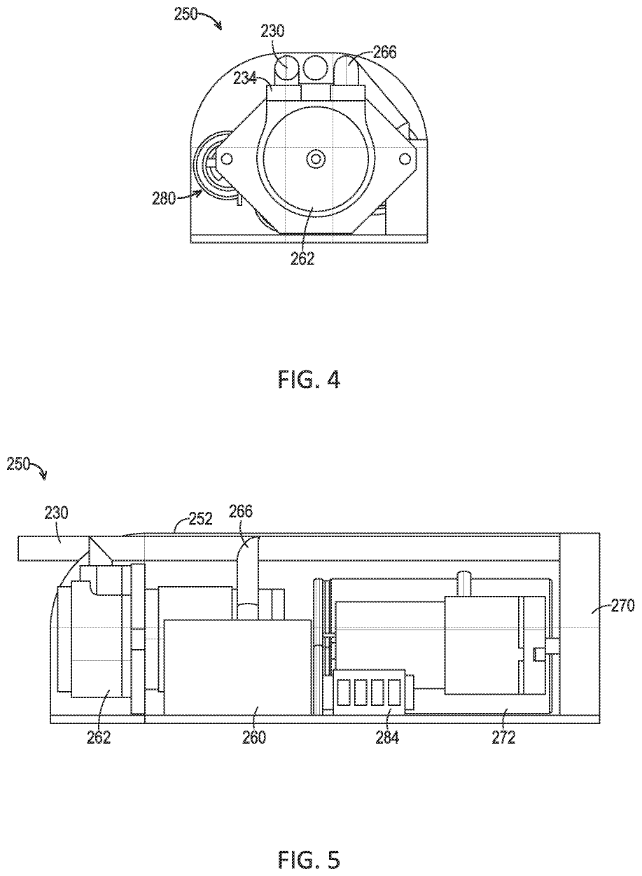

Arm-mounted module (AKA portable enclosure) 250 includes a housing 252 at least partially enclosing a water supply tank 260 coupled to the irrigation outlet by an irrigation line 266, a scavenge reservoir 270 coupled to the scavenge inlet by a scavenge line 276, a power supply 280, and pumps 262, 272 configured to pump fluid into and out of their respective reservoirs. FIGS. 4-6 depict end, side, and top views of internal components of arm-mounted module 250.

Housing 252 includes an elongate (e.g., rectangular, cuboidal, or the like) capsule, which is configured to retain and protect internal components associated with the arm-mounted module. In some examples, housing 252 includes a lid and a base, which are configured to snap together and apart, providing access to the internal components. Housing 252 is configured to be coupled and/or releasably secured to the arm (e.g., forearm) of a wearer via an armband or sleeve 254. Armband 254 comprises an elastic material, such as neoprene, fabrics comprising polyether-polyurea copolymers, synthetic polymer fabrics, and/or the like. Armband 254 is configured to loop around the arm of the wearer and fasten to itself, using any suitable fastener such as hook-and-loop fasteners, snaps, buttons, and/or the like. In some examples, housing 252 includes a pair of slots, apertures, and/or openings disposed in a back surface, which are configured to receive the armband. In some examples, housing 252 is configured to be received by an elastic sleeve, to which the armband is coupled (e.g., sewn, attached with hook-and-loop fasteners, etc.).

In some examples, housing 252 includes recesses disposed in external surfaces which are configured to receive water supply tank 260 and scavenge reservoir 270. For example, housing 252 may include an opening 264 disposed in a side portion of the housing, which is configured to receive water supply tank 260. Water supply tank 260 comprises a refillable and/or modular tank, which may include a sealing lid and is configured to fit snugly within opening 264. In some examples, housing 252 may include fasteners configured to retain water supply tank 260 within the housing. In some examples, the elastic sleeve is configured to retain the water supply within the housing. Water supply tank 260 is removable through opening 264, and may be filled and/or disinfected while disconnected from housing 252. In some examples, irrigation line 266 is similarly removable through opening 264.

Housing 252 includes a recess 274 disposed at a distal end of arm-mounted module 250. In some examples, the entire distal end of module 250 is open and configured to mate with scavenge reservoir 270. Scavenge reservoir 270 comprises a tank (e.g., modular and/or disposable), which may include a sealing lid and is configured to fit snugly within recess 274. In some examples, housing 252 includes fasteners configured to retain scavenge reservoir 270 within the housing. In some examples, the elastic sleeve is configured to retain the water supply within the housing. In some examples, scavenge reservoir 270 is configured to mate with housing 252 in a friction fit. Scavenge reservoir 270 may be detached from recess 274 for emptying and/or disinfection while disconnected from housing 252. In some examples, scavenge tube 240 extends along a top surface of arm-mounted module 250, and interfaces with scavenge reservoir 270 at a coupling or valve disposed on an external surface of scavenge reservoir 270.

Water supply tank 260 holds fresh (e.g., potable) water, which is configured to be pumped away from module 250 toward the oscillating toothbrush head. Accordingly, water supply tank 260 interfaces with a water pump 262 disposed within housing 252. Water pump 262 pumps water from water supply tank 260, through irrigation line 266 and through the pump into irrigation tube 230. The water subsequently travels through the irrigation tube into the mouth of the patient. In some examples, pump 262 is a peristaltic pump, although any suitable pump may be utilized.

Similarly, scavenge reservoir 270 is configured to hold waste collected from the mouth of the patient. Accordingly, scavenge reservoir 270 interfaces with a vacuum pump 272 configured to suction waste from the patient's mouth into the scavenge reservoir. Waste travels from the patient's mouth through scavenge tube 240, through scavenge inlet 244, through either an irrigation line coupled to the scavenge reservoir or through an extension of scavenge tube 240, and into scavenge reservoir 270. Vacuum pump 272 is disposed adjacent scavenge reservoir 270, but does not contact any waste. In some examples, vacuum pump 272 may be insulated from waste by a seal or filter. In some examples, pump 272 is a peristaltic pump, although any suitable pump may be utilized.

Pumps 262 and 272 are powered by a power supply 280. In some examples, power supply 280 includes a battery or a plurality of batteries 282. In some examples, battery 282 includes a rechargeable, e.g., lithium-ion battery. In some examples, batteries 282 include a plurality of alkaline batteries. In some examples, arm-mounted module 250 includes a charge indicator 284 configured to alert a user as to the state of charge of the arm-mounted module. In some examples, charge indicator 284 includes a plurality of LED indicators. In examples wherein batteries included in the power supply are rechargeable, the arm-mounted module may include a charging circuit 286 coupled to a charge port, which is configured to facilitate charging the device without removing the batteries.

Arm-mounted module 250 may be any suitable size for an arm-mounted system. In some examples, arm-mounted module may have a length of 5 inches to 7 inches, a width of 2 inches to 3 inches, and a height of 1.5 inches to 2.5 inches.

### C. Third Illustrative Tooth Cleaning System

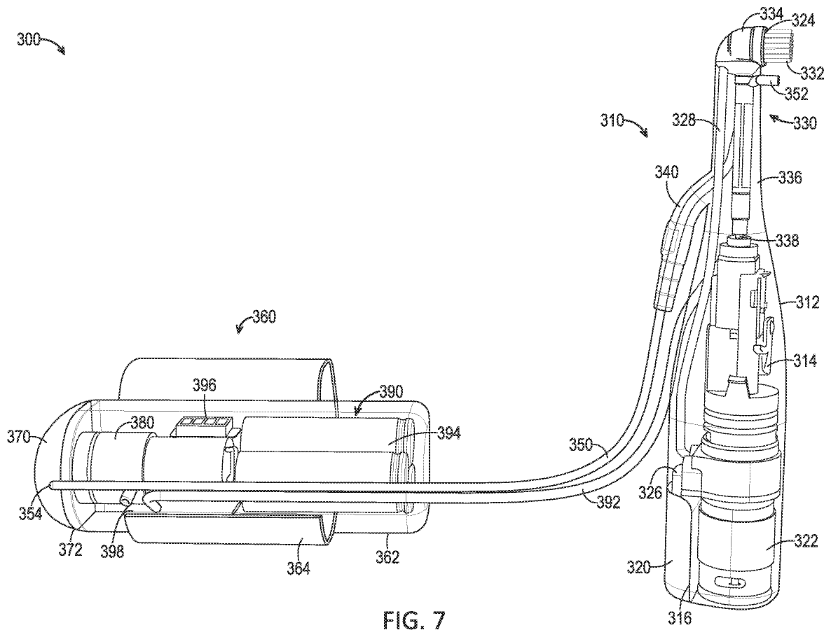

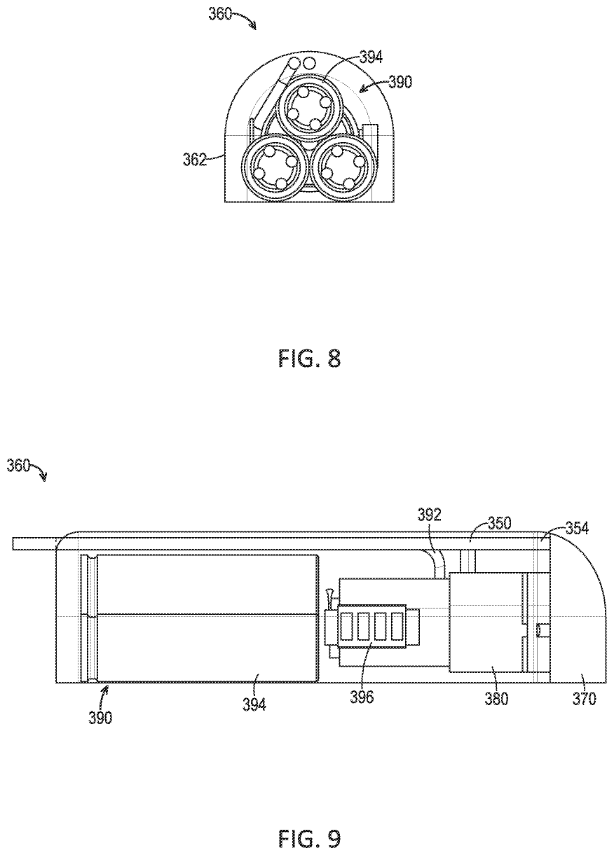

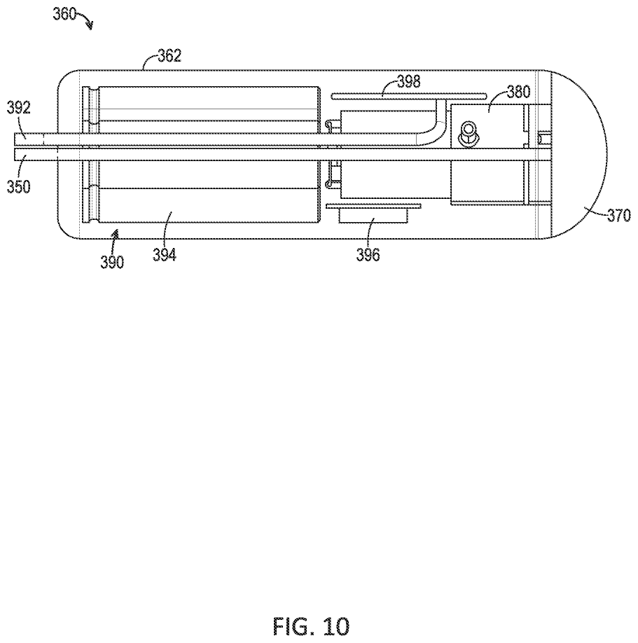

As shown in FIGS. 7-10, this section describes a third illustrative tooth cleaning system 300. FIG. 7 depicts an isometric view of illustrative tooth cleaning system 300. FIGS. 4-6 depict end, side, and top views of internal components of an arm-mounted module 360.

As depicted in FIG. 7, tooth cleaning system 300 includes a handheld toothbrush portion 310 coupled by a flexible scavenge tube 350 and an umbilical power cord 392 to an arm-mounted module 360. Handheld toothbrush portion 310 includes a toothbrush housing 312 coupled to an oscillating toothbrush head 330. Oscillating toothbrush head 330 may be removably coupled to housing 312 (e.g., by a threaded or friction fit) such that head 330 may be detached from all electronic components for cleaning (e.g., using a dishwasher, autoclave, etc.).

Toothbrush housing (AKA handle) 312 is configured to house a motor 314, a water supply tank 320, and a water pump 322. The motor may include any suitable prime mover configured to rotate and/or oscillate bristles of a toothbrush head, such as an electric motor (e.g., a brushed DC motor), a human powered oscillator, an inductive motor, a heat-powered motor and/or the like. Motor 314 is removably coupled to oscillating toothbrush head 330, and is configured to induce brush agitation in the toothbrush head. Motor 314 is powered by an umbilical power cord 392, which extends between a power supply 390 disposed within arm-mounted module 360 and the motor.

Umbilical cord 392 additionally powers water pump 322, which pumps water between water supply tank 320 and an irrigation port 324 disposed adjacent oscillating toothbrush head 330. Housing 312 includes a recess 316 disposed at a bottom end of the housing, which is configured to receive water supply 320. Water supply tank 320 includes a tank which is configured to be removed from the toothbrush housing to be cleaned and filled. Water reservoir is coupled to water pump 322 by an internal water line 326.

In some examples, housing 312 includes a user interface, such as a plurality of buttons and/or switches disposed on exterior surfaces of the housing, which may be configured to switch motor 314 between “on” and “off” states. In some examples, the buttons are configured to switch the motor between a variety of oscillation speeds. In some examples, the buttons are configured to switch pump 322 between “on” and “off” states. In some examples, the buttons are configured to switch the pump between a variety of pump powers. In some examples, the buttons are configured to control functions of components associated with arm-mounted module 360, such as scavenge. Housing 312 may comprise any suitable structural material for use in medical devices, such as plastics, metals, and/or the like. In some examples, the handheld toothbrush portion may include a resilient grip comprising any material which may be easily sterilized, such as rubber, resilient polymers, and/or the like.

In some examples, toothbrush housing 312 includes one or more lights coupled to the toothbrush housing. In some examples, the lights are directed toward oscillating toothbrush head 330, such that the lights illuminate the mouth of a patient during use. In some examples, the handheld toothbrush portion includes a plurality (e.g., two) LED lights disposed within light housings coupled to a front surface of the toothbrush housing. In some examples, the light housings are substantially tubular housings disposed around side portions of the LED lights, which direct light emitted by the LED lights parallel to a long axis of the handheld toothbrush portion. In some examples, the lights are electrically coupled to the plurality of buttons and/or switches, which are configured to switch the lights between an “on” state and an “off” state. Oscillating toothbrush head 330 includes a plurality of bristles 332 forming a brush head 334. Bristles 332 may be arrayed in any suitable arrangement for a toothbrush head, such as circular, ovular, rectangular, and/or the like. Brush head 334 is coupled to a stem 336, which is configured to oscillate as controlled by motor 314. In some examples, stem 336 includes a protrusion 338 disposed at a proximal end, which is configured to interface with the motor when the toothbrush head is coupled to the toothbrush housing. Toothbrush head 330 may comprise any suitable rigid material for use in medical devices, such as plastics, metals, and/or the like.

Coupled to oscillating toothbrush head 330 are an irrigation port or nozzle 324 and a scavenge port 352. Irrigation nozzle 324 is coupled to pump 322 by an irrigation tube 328, and may be formed as a single piece with irrigation tube 328. Irrigation nozzle 324 is configured to facilitate the flow of water from tube 328 into the mouth of a patient. In some examples, irrigation nozzle 324 comprises flexible tubing. In some examples, irrigation nozzle 324 comprises rigid tubing. Irrigation tube 328 comprises any suitable resilient material for use in medical tubing, such as silicone, polyvinyl chloride, latex, ethyl vinyl acetate, Tygon, and/or the like. In some examples, irrigation nozzle 324 is disposed adjacent to or at the center of brush head 334.

Scavenge port (AKA scavenge port) 352 is coupled to scavenge tube or scavenging tube 350, and may be formed as a single piece with scavenge tube 350. Scavenge port 352 is configured to facilitate the intake of waste (e.g., water, bodily fluids, food waste, etc.) from the mouth of a patient into tube 350, for example by suction. In some examples, scavenge port 352 comprises flexible tubing. In some examples, scavenge port 352 comprises rigid tubing. Scavenge tube 350 comprises any suitable resilient material for use in medical tubing, such as silicone, polyvinyl chloride, latex, ethyl vinyl acetate, Tygon, and/or the like.

In some examples, oscillating brush head 330 includes a sleeve 340 extending from a back edge of the brush head. Sleeve 340 is configured to receive scavenge tube 350. In some examples, scavenge port 352 is formed as a single piece with sleeve 340. In these examples, sleeve 340 includes ports disposed proximal to the toothbrush-arm-mounted module interface to which scavenge tube 350 may couple. In some examples, scavenge tube 350 may be fed through sleeve 340, which may retain tube 350 adjacent the toothbrush head while the toothbrush portion is in use. Tube 350 may be removed from sleeve 340 for cleaning. In some examples, tube 350 is heat-resistant and configured to be sanitized (e.g., using a dishwasher, autoclave, etc.).

Scavenge tube 350 may interface with arm-mounted module 360 through a scavenge inlet 354 coupled to a scavenge reservoir 370, which may be disposed at a distal end of the arm-mounted module. In some examples, scavenge inlet 354 comprises a rigid tube configured to mate with scavenge tube 350. In some examples, scavenge inlet 354 comprises a coupling, seal, or valve, which may provide a water-sealable fit when tube 350 is inserted into the coupling.

Arm-mounted module (AKA portable enclosure) 360 includes a housing 362 at least partially enclosing a scavenge reservoir 370, coupled to scavenge tube 350 by scavenge inlet 354, a pump 380, configured to vacuum and/or suction fluid into the scavenge reservoir, and a power supply 390.

Housing 362 includes an elongate (e.g., rectangular, cuboidal, or the like) capsule, which is configured to retain and protect internal components associated with the arm-mounted module. In some examples, housing 362 includes a lid and a base, which are configured to snap together and apart, providing access to the internal components. Housing 362 is configured to be coupled and/or releasably secured to the arm (e.g., forearm) of a wearer via an armband or sleeve 364. Armband 364 comprises an elastic material, such as neoprene, fabrics comprising polyether-polyurea copolymers, synthetic polymer fabrics, and/or the like. Armband 364 is configured to loop around the arm of the wearer and fasten to itself, using any suitable fastener such as hook-and-loop fasteners, snaps, buttons, and/or the like. In some examples, housing 362 includes a pair of slots, apertures, and/or openings disposed in a back surface, which are configured to receive the armband. In some examples, housing 362 is configured to be received by an elastic sleeve, to which the armband is coupled (e.g., sewn, attached with hook-and-loop fasteners, etc.).

In some examples, housing 362 includes a recess 372 disposed in an external surface, which is configured to receive scavenge reservoir 370. Recess 372 is disposed at a distal end of arm-mounted module 360. In some examples, the entire distal end of module 360 is open and configured to mate with scavenge reservoir 370. Scavenge reservoir 370 comprises a tank (e.g., modular and/or disposable), which may include a sealing lid and is configured to fit snugly within recess 372. In some examples, housing 362 includes fasteners configured to retain scavenge reservoir 370 within the housing. In some examples, the elastic sleeve is configured to retain the water supply within the housing. In some examples, scavenge reservoir 370 is configured to mate with housing 362 in a friction fit. Scavenge reservoir 370 may be detached from recess 372 for emptying and/or disinfection while disconnected from housing 362. In some examples, scavenge tube 350 extends along a top surface of arm-mounted module 360, and interfaces with scavenge reservoir 370 at a coupling or valve disposed on an external surface of scavenge reservoir 370.

Scavenge reservoir 370 is configured to hold waste collected from the mouth of the patient. Accordingly, scavenge reservoir 370 interfaces with a vacuum pump 380 configured to suction waste from the patient's mouth into the scavenge reservoir. Waste travels from the patient's mouth through scavenge tube 350, through scavenge inlet 352, and into scavenge reservoir 370. Vacuum pump 380 is disposed adjacent scavenge reservoir 370, but does not contact any waste. In some examples, vacuum pump 380 may be insulated from waste by a seal or filter. In some examples, vacuum pump 380 is a peristaltic pump, although any suitable pump may be utilized.

Pumps 322 and 380 are powered by a power supply 390. An umbilical power cord 392 extends from power supply 390 to pump 322. In some examples, the umbilical cord extends through an internal cavity of the arm-mounted module, and exits through a port disposed at a proximal end of the arm-mounted module. In some examples, the umbilical cord includes a male electrical coupling configured to mate with a corresponding female electrical coupling disposed on an external surface of handheld toothbrush 310. In some examples, power supply 390 includes a battery or a plurality of batteries 394. In some examples, battery 394 is a rechargeable, e.g., lithium-ion battery. In some examples, batteries 394 are a plurality of alkaline batteries. In some examples, arm-mounted module 360 includes a charge indicator 396 configured to alert a user as to the state of charge of the arm-mounted module. In some examples, charge indicator 396 includes a plurality of LED indicators disposed on an external surface of housing 362. In examples wherein batteries included in the power supply are rechargeable, the arm-mounted module may include a charging circuit 398 coupled to a charge port, which is configured to allow a user to charge the device without removing the batteries.

Arm-mounted module 360 may be any suitable size for an arm-mounted system. In some examples, arm-mounted module may have a length of 5 inches to 7 inches, a width of 1 inches to 2 inches, and a height of 1 inches to 2 inches.

### D. Fourth Illustrative Tooth Cleaning System

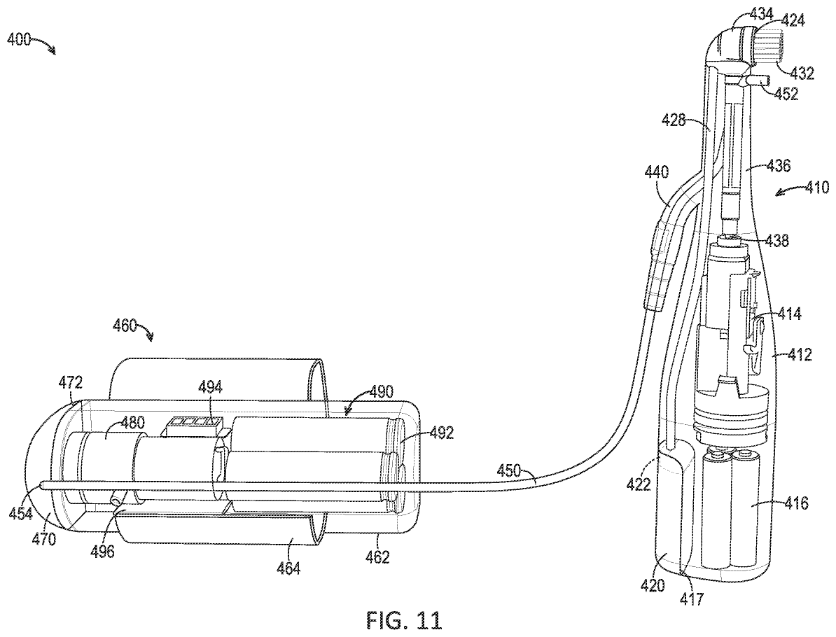

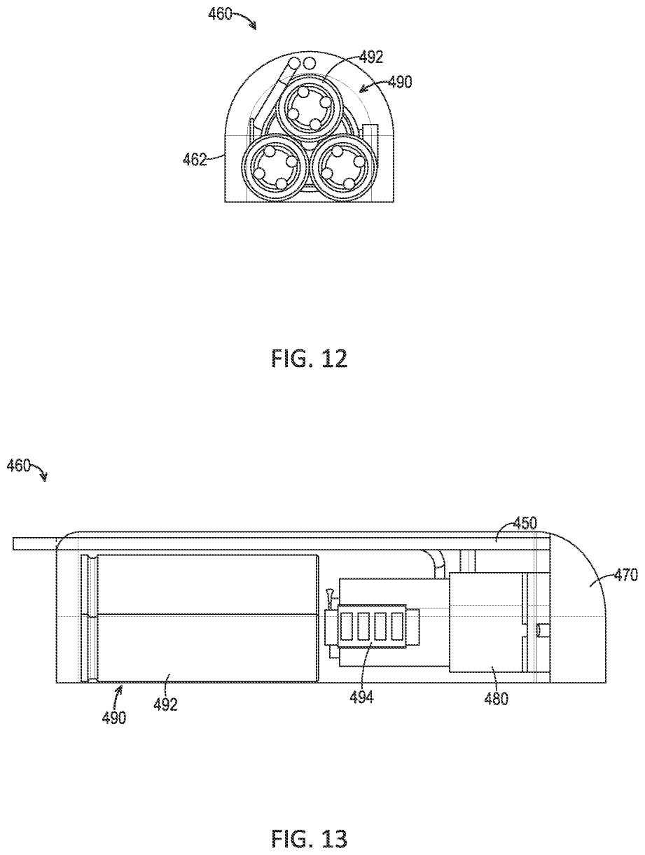

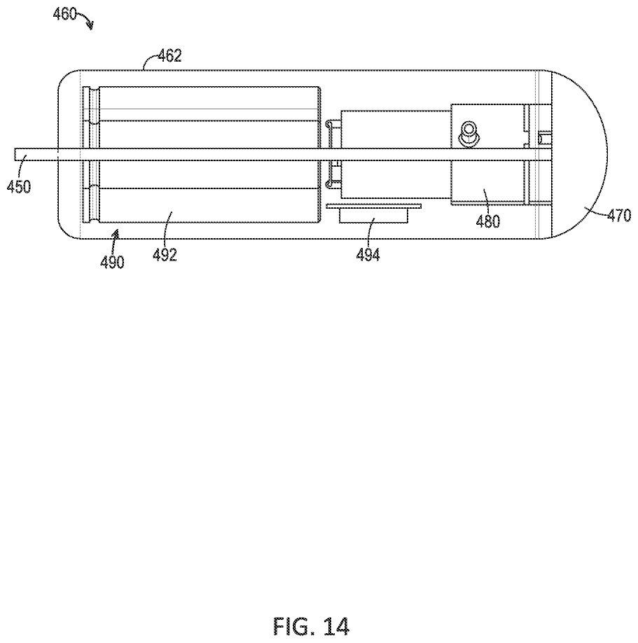

As shown in FIGS. 11-14, this section describes a fourth illustrative tooth cleaning system 400. FIG. 11 depicts an isometric view of illustrative tooth cleaning system 400. FIGS. 12-14 depict end, side, and top views of internal components of an arm-mounted module 460.

As depicted in FIG. 11, tooth cleaning system 400 includes a handheld toothbrush portion 410 coupled by a flexible scavenge tube 450 to an arm-mounted module 460. Handheld toothbrush portion 410 includes a toothbrush housing 412 coupled to an oscillating toothbrush head 430. Oscillating toothbrush head 430 may be removably coupled to housing 412 (e.g., by a threaded or friction fit) such that head 430 may be detached from all electronic components for cleaning (e.g., using a dishwasher, autoclave, etc.).

Toothbrush housing (AKA handle) 412 is configured to house a motor 414, a power supply 416, a water supply tank 420, and a water pump 422. Motor 414 is removably coupled to oscillating toothbrush head 430, and is configured to induce brush agitation in the toothbrush head. The motor may include any suitable prime mover configured to rotate and/or oscillate bristles of a toothbrush head, such as an electric motor (e.g., a brushed DC motor), a human powered oscillator, an inductive motor, a heat-powered motor and/or the like. Motor 414 is powered by power supply 416, which may include one or more batteries. In some examples, power supply 416 includes a plurality of alkaline batteries. In some examples, power supply 416 includes a rechargeable, e.g., lithium-ion battery.

Water pump 422 pumps water between water supply tank 420 and an irrigation nozzle 424 disposed at or adjacent oscillating toothbrush head 430. Water pump 422 is manually actuated, and does not include an external power supply. In some examples, water pump 422 comprises a piston-activated positive displacement pump shaft disposed within water supply tank 420. In some examples, water pump 422 includes a trigger, button, or other actuator disposed on an external surface of water supply tank 420. In some examples, water supply tank 420 comprises an elastic material (e.g., silicone, latex, etc.) and actuating water pump 422 comprises applying external pressure to the walls of water supply tank 420. Housing 412 includes a recess 417 disposed at a bottom end of the housing, which is configured to receive water supply tank 420. Water supply tank 420 includes a tank which is configured to be removed from the toothbrush housing to be cleaned and filled.

In some examples, housing 412 includes a user interface, such as a plurality of buttons and/or switches disposed on exterior surfaces of the housing, which may be configured to switch motor 414 between “on” and “off” states. In some examples, the buttons are configured to switch the motor between a variety of oscillation speeds. In some examples, the buttons are configured to control functions of components associated with arm-mounted module 460, such as scavenge. Housing 412 may comprise any suitable structural material for use in medical devices, such as plastics, metals, and/or the like. In some examples, the handheld toothbrush portion may include a resilient grip comprising any material which may be easily sterilized, such as rubber, resilient polymers, and/or the like.

In some examples, toothbrush housing 412 includes one or more lights coupled to the toothbrush housing. In some examples, the lights are directed toward oscillating toothbrush head 430, such that the lights illuminate the mouth of a patient during use. In some examples, the handheld toothbrush portion includes a plurality (e.g., two) LED lights disposed within light housings coupled to a front surface of the toothbrush housing. In some examples, the light housings are substantially tubular housings disposed around side portions of the LED lights, which direct light emitted by the LED lights parallel to a long axis of the handheld toothbrush portion. In some examples, the lights are electrically coupled to the plurality of buttons and/or switches, which are configured to switch the lights between an “on” state and an “off” state.

Oscillating toothbrush head 430 includes a plurality of bristles 432 forming a brush head 434. Bristles 432 may be arrayed in any suitable arrangement for a toothbrush head, such as circular, ovular, rectangular, and/or the like. Brush head 434 is coupled to a stem 436, which is configured to oscillate as controlled by motor 414. In some examples, stem 436 includes a protrusion 438 disposed at a proximal end, which is configured to interface with the motor when the toothbrush head is coupled to the toothbrush housing. Toothbrush head 430 may comprise any suitable rigid material for use in medical devices, such as plastics, metals, and/or the like.

Coupled to oscillating toothbrush head 430 are an irrigation port or nozzle 424 and a scavenge port 452. Irrigation nozzle 424 is coupled to pump 422 by an irrigation tube 428, and may be formed as a single piece with the tube. Irrigation nozzle 424 is configured to facilitate the flow of water from tube 428 into the mouth of a patient. In some examples, irrigation nozzle 424 comprises flexible tubing. In some examples, irrigation nozzle 424 comprises rigid tubing. Irrigation tube 428 comprises any suitable resilient material for use in medical tubing, such as silicone, polyvinyl chloride, latex, ethyl vinyl acetate, Tygon, and/or the like. In some examples, irrigation nozzle 424 is disposed adjacent to or at the center of brush head 434.

Scavenge port (AKA scavenging port) 452 is coupled to scavenge tube or scavenging tube 450, and may be formed as a single piece with scavenge tube 450. Scavenge port 452 is configured to facilitate the intake of waste (e.g., water, bodily fluids, food waste, etc.) from the mouth of a patient into tube 450, for example by suction. In some examples, scavenge port 452 comprises flexible tubing. In some examples, scavenge port 452 comprises rigid tubing. Scavenge tube 450 comprises any suitable resilient material for use in medical tubing, such as silicone, polyvinyl chloride, latex, ethyl vinyl acetate, Tygon, and/or the like.

In some examples, oscillating brush head 430 includes a sleeve 440 extending from a back edge of the brush head. Sleeve 440 is configured to receive scavenge tube 450. In some examples, scavenge port 452 is formed as a single piece with sleeve 440. In these examples, sleeve 440 includes a port disposed proximal to the toothbrush-arm-mounted module interface to which scavenge tube 450 may couple. In some examples, scavenge tube 450 may be fed through sleeve 440, which may retain tube 450 adjacent the toothbrush head while the toothbrush portion is in use. Tube 450 may be removed from sleeve 440 for cleaning. In some examples, tube 450 is heat-resistant and configured to be sanitized (e.g., using a dishwasher, autoclave, etc.).

Scavenge tube 450 may interface with arm-mounted module 460 through a scavenge inlet 454 coupled to a scavenge reservoir 470, which may be disposed at a distal end of the arm-mounted module. In some examples, scavenge inlet 454 comprises a rigid tube configured to mate with scavenge tube 450. In some examples, scavenge inlet 454 comprises a coupling, seal, or valve, which may provide a water-sealable fit when tube 450 is inserted into the coupling.

Arm-mounted module (AKA portable enclosure) 460 includes a housing 462 at least partially enclosing a scavenge reservoir 470 coupled to scavenge tube 450 by scavenge inlet 454, a pump 480 configured to vacuum and/or suction fluid into the scavenge reservoir, and a power supply 490.

Housing 462 includes an elongate (e.g., rectangular, cuboidal, or the like) capsule, which is configured to retain and protect internal components associated with the arm-mounted module. In some examples, housing 462 includes a lid and a base, which are configured to snap together and apart, providing access to the internal components. Housing 462 is configured to be coupled and/or releasably secured to the arm of a wearer via an armband or sleeve 464. Armband 464 comprises an elastic material, such as neoprene, fabrics comprising polyether-polyurea copolymers, synthetic polymer fabrics, and/or the like. Armband 464 is configured to loop around the arm (e.g., forearm) of the wearer and fasten to itself, using any suitable fastener such as hook-and-loop fasteners, snaps, buttons, and/or the like. In some examples, housing 462 includes a pair of slots, apertures, and/or openings disposed in a back surface, which are configured to receive the armband. In some examples, housing 462 is configured to be received by an elastic sleeve, to which the armband is coupled (e.g., sewn, attached with hook-and-loop fasteners, etc.).

In some examples, housing 462 includes a recess 472 disposed in an external surface, which is configured to receive scavenge reservoir 470. Recess 472 is disposed at a distal end of arm-mounted module 460. In some examples, the entire distal end of module 460 is open and configured to mate with scavenge reservoir 470. Scavenge reservoir 470 comprises a tank (e.g., modular and/or disposable), which may include a sealing lid and is configured to fit snugly within recess 472. In some examples, housing 462 includes fasteners configured to retain scavenge reservoir 470 within the housing. In some examples, the elastic sleeve is configured to retain the water supply within the housing. In some examples, scavenge reservoir 470 is configured to mate with housing 462 in a friction fit. Scavenge reservoir 470 may be detached from recess 472 for emptying and/or disinfection while disconnected from housing 462. In some examples, scavenge tube 450 extends along a top surface of arm-mounted module 460, and interfaces with scavenge reservoir 470 at a coupling or valve disposed on an external surface of scavenge reservoir 470.

Scavenge reservoir 470 is configured to hold waste collected from the mouth of the patient. Accordingly, scavenge reservoir 470 interfaces with a vacuum pump 480 configured to suction waste from the patient's mouth into the scavenge reservoir. Waste travels from the patient's mouth through scavenge tube 450, through scavenge inlet 452, and into scavenge reservoir 470. Vacuum pump 480 is disposed adjacent scavenge reservoir 470, but does not contact any waste. In some examples, vacuum pump 480 may be insulated from waste by a seal or filter. In some examples, pump 480 is a peristaltic pump, although any suitable pump may be utilized.

Pump 480 is powered by a power supply 490. In some examples, power supply 490 is a battery or a plurality of batteries 492. In some examples, battery 492 is a rechargeable, e.g., lithium-ion battery. In some examples, batteries 492 are a plurality of alkaline batteries. In some examples, arm-mounted module 460 includes a charge indicator 494 configured to alert a user as to the state of charge of the arm-mounted module. In some examples, charge indicator 494 includes a plurality of LED indicators disposed on an external surface of housing 462. In examples wherein batteries included in the power supply are rechargeable, the arm-mounted module may include a charging circuit 496 coupled to a charge port, which is configured to allow a user to charge the device without removing the batteries.

Arm-mounted module 460 may be any suitable size for an arm-mounted system. In some examples, arm-mounted module may have a length of 5 inches to 7 inches, a width of 1 inches to 2 inches, and a height of 1 inches to 2 inches.

### E. Illustrative Method

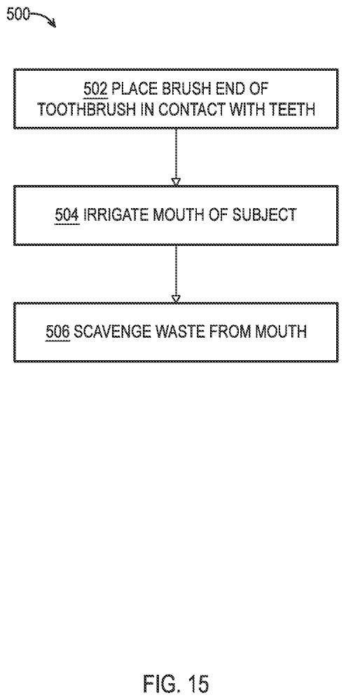

This section describes steps of an illustrative method 500 for improving the oral hygiene of a patient or other subject; see FIG. 15. Aspects of portable electric toothbrush systems described above may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method, and may not recite the complete process or all steps of the method. Although various steps of method 500 are described below and depicted in FIG. 15, the steps need not necessarily all be performed, and in some cases may be performed simultaneously or in a different order than the order shown.

Step 502 of method 500 includes placing a brush end of an electric toothbrush into contact with one or more teeth in a mouth of a subject, wherein the electric toothbrush includes an irrigation nozzle and a scavenging port, and the electric toothbrush is part of a self-contained system, being coupled to a forearm-mounted enclosure housing a waste collection system. In some examples, forearm-mounted enclosure further comprises a rechargeable battery configured to power the waste collection system.

Step 504 of method 500 includes irrigating the mouth of the subject by pumping water from a water supply tank through the irrigation nozzle of the toothbrush. In some examples, the water supply tank is housed in the forearm-mounted enclosure. In some examples, the water supply tank is housed in a handle of the toothbrush. In some examples, pumping water from the water supply tank through the irrigation nozzle includes operating a manual pump disposed in a handle of the toothbrush.

Step 506 of method 500 includes scavenging waste from the mouth of the subject by pumping liquid through the scavenging port to the waste collection system. In some examples, the waste collection system comprises a waste collection tank and a vacuum pump.

### F. Illustrative Combinations and Additional Examples

This section describes additional aspects and features of tooth cleaning systems, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A self-contained portable electric toothbrush system, comprising:

an electric toothbrush having a head portion coupled to a handle, the head portion including a brush, an irrigation nozzle, and a scavenging port;

a portable enclosure housing a first pump and a waste tank, the portable enclosure being coupled to the toothbrush by at least one flexible tube and comprising a sleeve, such that the portable enclosure is configured to be releasably securable to an arm of a user; and

a water supply tank coupled to the irrigation nozzle of the electric toothbrush;

wherein the at least one flexible tube includes a scavenging tube coupled at a first end to the scavenging port of the toothbrush and at a second end to the waste tank.

A1. The portable electric toothbrush system of A0, wherein the water supply tank is disposed in the portable enclosure, and the at least one flexible tube includes a water supply tube coupled to the irrigation nozzle.

A2. The portable electric toothbrush system of A1, the portable enclosure further housing a second pump, wherein the first pump is a vacuum pump coupled to the waste tank and the second pump is a water supply pump configured to move water from the water supply tank through the water supply tube.

A3. The portable electric toothbrush system of A1, wherein the first pump is configured to move liquid waste through the scavenging tube and to move water from the water supply tank through the water supply tube.

A4. The portable electric toothbrush system of A3, wherein the first pump is a peristaltic pump operatively coupled both to the scavenging tube and to the water supply tube.

A5. The portable electric toothbrush system of A0, wherein the water supply tank is disposed in the handle of the electric toothbrush, and the water supply tank is coupled to the irrigation nozzle by a water supply tube.

A6. The portable electric toothbrush system of A5, wherein the at least one flexible tube coupling the portable enclosure to the toothbrush includes only the scavenging tube.

A7. The portable electric toothbrush system of A5 or A6, wherein the handle of the toothbrush further comprises a hand-operated pump configured to move water from the water supply tank to the irrigation nozzle.

A8. The portable electric toothbrush system of any one of paragraphs A0 through A7, wherein the sleeve comprises two elastic portions releasably securable to each other.

A9. The portable electric toothbrush system of A8, wherein the two elastic portions include hook and loop fasteners.

B0. A portable electric toothbrush system, comprising:

an electric toothbrush having a head portion coupled to a handle, the head portion including a brush and a scavenging port;

a portable enclosure housing a vacuum pump coupled to a waste tank, the portable enclosure being coupled to the toothbrush by a flexible scavenging tube and comprising an arm sleeve configured to hold the portable enclosure to a forearm of a user; and

a portable power supply electrically coupled to the vacuum pump;

wherein the scavenging tube is coupled at a first end to the scavenging port of the toothbrush and at a second end to the waste tank.

B1. The portable electric toothbrush system of B0, further comprising a water supply tank coupled to an irrigation nozzle of the electric toothbrush.

B2. The portable electric toothbrush system of B1, wherein the water supply tank is disposed in the handle of the toothbrush.

B3. The portable electric toothbrush system of B1, wherein the water supply tank is disposed in the portable enclosure.

B4. The portable electric toothbrush system of any one of paragraphs B0 through B3, wherein the portable power supply comprises a battery housed in the portable enclosure.

B5. The portable electric toothbrush system of any one of paragraphs B0 through B4, wherein the portable power supply is further electrically coupled to a motor configured to oscillate the brush of the toothbrush.

C0. A method for brushing the teeth of a subject, the method comprising:

placing a brush end of an electric toothbrush into contact with one or more teeth in a mouth of the subject, wherein the electric toothbrush includes an irrigation nozzle and a scavenging port, and the electric toothbrush is coupled to a forearm-mounted enclosure housing a waste collection system;

irrigating the mouth of the subject by pumping water from a water supply tank through the irrigation nozzle of the toothbrush; and

scavenging waste from the mouth of the subject by pumping liquid through the scavenging port to the waste collection system.

C1. The method of C0, wherein the water supply tank is housed in the forearm-mounted enclosure.

C2. The method of C0, wherein the water supply tank is housed in a handle of the toothbrush.

C3. The method of any one of paragraphs C0 through C2, wherein the waste collection system comprises a waste collection tank and a vacuum pump.

C4. The method of C0, wherein pumping water from the water supply tank through the irrigation nozzle includes operating a manual pump disposed in a handle of the toothbrush.

C5. The method of any one of paragraphs C0 through C4, wherein the forearm-mounted enclosure further comprises a rechargeable battery configured to power the waste collection system.

### Advantages, Features, and Benefits

The different embodiments and examples of the tooth cleaning system described herein provide several advantages over known solutions for cleaning patients' teeth in a dependent care setting (e.g., ICU, extended care facility, home healthcare). For example, illustrative embodiments and examples described herein allow easy sanitation of internal components, which allows a single toothbrush to be used to clean the teeth of multiple patients.

Additionally, and among other benefits, illustrative embodiments and examples described herein provide a completely portable system able to both irrigate and suction the mouth of a patient, improving tooth cleaning experience for patients, e.g., for patients unable to care for their own oral hygiene. Convenience and usability are enhanced by the self-contained nature of the apparatus.

Additionally, and among other benefits, illustrative embodiments and examples described herein provide a completely portable system that does not require an external power supply, an external drainage system, and/or an external water supply, those things being included within the portable assembly (e.g., one or more being housed in the arm-mounted module).

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A self-contained portable electric toothbrush system, comprising:
an electric toothbrush having a head portion coupled to a handle, the head portion including a brush, an irrigation nozzle, and a scavenging port and wherein a housing of the handle defines an outer profile;
a wearable enclosure housing a vacuum pump and a waste tank, the wearable enclosure being coupled to the toothbrush by at least one flexible tube and comprising a sleeve, such that the wearable enclosure is configured to be releasably securable to an arm of a user; and
a water supply tank coupled to the irrigation nozzle of the electric toothbrush and configured to provide water to the irrigation nozzle via manual actuation, wherein the water supply tank is disposed within the handle such that no portion of the water supply tank extends beyond the outer profile of the handle;
wherein the at least one flexible tube includes a scavenging tube coupled at a first end to the scavenging port of the toothbrush and at a second end to the waste tank.

2-5. (canceled)

6. The self-contained portable electric toothbrush system of claim 1, wherein the handle of the electric toothbrush includes a recess disposed at a bottom end portion of the handle, and the recess is configured to removably receive the water supply tank.

7. The self-contained portable electric toothbrush system of claim 1, wherein the at least one flexible tube coupling the wearable enclosure to the toothbrush includes only the scavenging tube.

8. (canceled)

9. The self-contained portable electric toothbrush system of claim 1, wherein the sleeve comprises two elastic portions releasably securable to each other.

10. The self-contained portable electric toothbrush system of claim 9, wherein the two elastic portions include hook and loop fasteners.

11. A portable electric toothbrush system, comprising:
an electric toothbrush having a head portion coupled to a handle, the head portion including an irrigation nozzle, a brush, and a scavenging port;
a water supply tank coupled to the irrigation nozzle of the electric toothbrush and configured to provide water to the irrigation nozzle via manual actuation, wherein the water supply tank is arranged within a recess disposed at a bottom end of the handle, such that a bottom surface of the water supply tank lies flush with the bottom end of the handle;
a wearable enclosure housing a vacuum pump coupled to a waste tank, the wearable enclosure being coupled to the toothbrush by a flexible scavenging tube and comprising an arm sleeve configured to hold the wearable enclosure to a forearm of a user; and
a portable power supply electrically coupled to the vacuum pump;
wherein the scavenging tube is coupled at a first end to the scavenging port of the toothbrush and at a second end to the waste tank.

12. The portable electric toothbrush system of claim 11, wherein the water supply tank is coupled to the irrigation nozzle of the electric toothbrush by an irrigation tube.

13. The portable electric toothbrush system of claim 12, wherein the handle of the electric toothbrush is configured to removably receive the water supply tank in the recess disposed at the bottom end of the handle.

14. (canceled)

15. The portable electric toothbrush system of claim 11, wherein the portable power supply comprises a battery housed in the wearable enclosure.

16. (canceled)

17. A method for brushing the teeth of a subject, the method comprising:
placing a brush end of an electric toothbrush into contact with one or more teeth in a mouth of the subject, wherein the electric toothbrush includes an irrigation nozzle and a scavenging port, and the electric toothbrush is coupled to a forearm-mounted enclosure housing a waste collection system;
irrigating the mouth of the subject by manually pumping water from a water supply tank through the irrigation nozzle of the toothbrush; and
scavenging waste from the mouth of the subject by pumping liquid through the scavenging port to the waste collection system.

18. (canceled)

19. The method of claim 17, wherein the water supply tank is housed in a handle of the toothbrush.

20. (canceled)

21. The method of claim 17, wherein pumping water from the water supply tank through the irrigation nozzle includes operating a manual pump disposed in a handle of the toothbrush.

22. (canceled)

23. The self-contained portable electric toothbrush system of claim 1, wherein the water supply tank coupled to the irrigation nozzle of the electric toothbrush has at least one compressible wall, such that applying pressure to the compressible wall causes water in the water supply tank to move from the water supply tank to the irrigation nozzle.

24. The self-contained portable electric toothbrush system of claim 23, wherein the at least one compressible wall of the water supply tank comprises an elastic material.

25. The self-contained portable electric toothbrush system of claim 1, wherein the water supply tank is coupled to the irrigation nozzle by an irrigation tube.

26. The self-contained portable electric toothbrush system of claim 6, wherein the water supply tank is configured to removably fit within the recess of the handle of the toothbrush, such that an external surface of the water supply tank lies flush with an external surface of the handle.

27. The portable electric toothbrush system of claim 13, wherein an external surface of the water supply tank is flush with an external surface of the handle of the toothbrush when the water supply tank is disposed in the recess of the handle.

28. A self-contained portable electric toothbrush system, comprising:
an electric toothbrush having a head portion coupled to a handle, the head portion including a brush, an irrigation nozzle, and a scavenging port;
a wearable enclosure housing a vacuum pump and a waste tank, the wearable enclosure being coupled to the toothbrush by at least one flexible tube and comprising a sleeve, such that the wearable enclosure is configured to be releasably securable to an arm of a user; and
a water supply tank coupled to the irrigation nozzle of the electric toothbrush and configured to provide water to the irrigation nozzle via manual actuation, wherein the water supply tank is arranged within a recess of the handle, the recess configured to receive the water supply tank, such that an external surface of the water supply tank lies flush with an external surface of the handle;
wherein the at least one flexible tube includes a scavenging tube coupled at a first end to the scavenging port of the toothbrush and at a second end to the waste tank.

29. The portable electric toothbrush system of claim 28, wherein the water supply tank is coupled to the irrigation nozzle of the electric toothbrush and includes a compressible wall configured to actuate the water supply tank, such that applying pressure to the compressible wall of the water supply tank forces water to move from the water supply tank to the irrigation nozzle.

30. The portable electric toothbrush system of claim 29, wherein the compressible wall of the water supply tank comprises an elastic material.
